(19) United States
(12) Patent Application Publication
(10) Pub. No.: US 2019/0379661 A1
(43) Pub. Date: Dec. 12, 2019

(54) INFORMATION PROCESSING SYSTEM AND CONTROL METHOD THEREFOR

(71) Applicant: CANON KABUSHIKI KAISHA, Tokyo (JP)

(72) Inventor: Junji Sato, Kawasaki-shi (JP)

(21) Appl. No.: 16/407,927

(22) Filed: May 9, 2019

(30) Foreign Application Priority Data
Jun. 8, 2018 (JP) 2018-110453

(51) Int. Cl. H04L 29/06; H04L 29/08

(52) U.S. Cl. CPC H04L 63/0876; H04L 67/10

(57) ABSTRACT

In an information processing system, a management server transmits identified setting data and identified local server information to an authenticated information processing apparatus, and, when acquiring content data according to an instruction included in the setting data acquired from the management server, the information processing apparatus accesses a local server with use of the local server information acquired from the management server and acquires the content data managed by the local server.

### BACKGROUND

### Field of the Disclosure

Aspects of the present disclosure generally relate to an information processing system which sets content data acquired from a local server or a content server, and to a control method for the information processing system.

### Description of the Related Art

In installing an information processing apparatus, such as a digital multifunction peripheral, at a customer's location, an appropriate setting operation which complies with a customer's request is required. The setting operation includes, for example, executing a number of items such as updating of firmware, changing of various setting values, and installation of an application. Manually executing such a setting operation is not only time-consuming but also apt to cause human errors. Moreover, for example, in a large-scale business meeting, the same setting operation may be implemented on a plurality of information processing apparatuses, so that a manually manipulated setting operation is not efficient.

Therefore, there is an information processing system which previously generates setting data in which the contents of a setting operation are defined and automatically executes the setting operation based on the setting data. The setting data is generated by a sales representative based on a customer's request. Then, an operator downloads required content data, such as firmware or an application, to the information processing apparatus with use of the setting data at, for example, a factory.

At that time, in a case where the file size of content data to be downloaded is large, a large load may be put on a network or downloading may take much time. Particularly, in a case where the same content data is used in setting operations for a plurality of information processing apparatuses, it is inefficient to download the content data from an external server during each setting operation.

Japanese Patent Application Laid-Open No. 2017-21407 discusses a configuration in which, to reduce a load on a network, an information processing apparatus that has first downloaded content data serves as a web server, which releases content data, and, during a setting operation for another information processing apparatus, the web server delivers the content data via an intranet, thus attaining a reduction in the setting operation time.

### SUMMARY

According to an aspect of the present disclosure, an information processing system includes an information processing apparatus, a management server configured to manage setting data including an instruction to install content data including at least one of an application for implementing a function of the information processing apparatus and firmware for causing the application to operate, and a local server configured to manage at least a part of the content data, wherein the management server includes an identification unit configured to identify, based on a request from the information processing apparatus, the setting data and local server information including authentication information for accessing the local server, and an authentication unit configured to authenticate the information processing apparatus, wherein the management server transmits the setting data and the local server information identified by the identification unit to the information processing apparatus authenticated by the authentication unit, and wherein, when acquiring the content data according to an instruction included in the setting data acquired from the management server, the information processing apparatus accesses the local server with use of the local server information acquired from the management server and acquires the content data managed by the local server.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration of an information processing system.

FIG. 2 is a diagram illustrating an example of a hardware configuration of a management server.

FIG. 3 is an explanatory diagram illustrating an example of a hardware configuration of a device.

FIG. 4 is a diagram illustrating examples of software configurations of the management server, the device, and a local server.

FIGS. 5A, 5B, 5C, 5D, and 5E are diagrams illustrating examples of setting data.

FIG. 6 is a diagram illustrating an example of local server information.

FIG. 7 is a flowchart illustrating an example of automatic setting processing, which is performed by the device.

FIG. 8 is a flowchart illustrating an example of setting data transmission processing, which is performed by the management server.

FIG. 9 is a diagram illustrating an example of a screen used to search for setting data.

FIG. 10 is a diagram illustrating an example of a screen which is displaying the contents of setting data.

FIGS. 11A and 11B are diagrams illustrating examples of setting data which the management server transmits to the device.

FIGS. 12A, 12B, and 12C are diagrams illustrating examples of setting data acquisition requests which the device transmits to the management server.

FIG. 13 is a diagram illustrating an example of a setting history.

FIGS. 14A and 14B are diagrams illustrating examples of local server information acquisition requests which the device transmits to the management server.

FIG. 15 is a flowchart illustrating an example of local server information transmission processing, which is performed by the management server.

FIG. 16 is a diagram illustrating an example of a screen which is displaying failure of acquisition of local server information.

FIG. 17 is a diagram illustrating an example of a setting history in a second exemplary embodiment.

FIG. 18 is a flowchart illustrating an example of local server information transmission processing, which is performed by the management server in the second exemplary embodiment.

FIG. 19 is a diagram illustrating an example of a local server selection screen.

FIG. 20 is a diagram illustrating an example of a setting data selection screen.

FIG. 21 is a sequence diagram illustrating an example of processing for an automatic setting operation using a local server.

FIG. 22 is a sequence diagram illustrating an example of processing for an automatic setting operation in a third exemplary embodiment.

FIG. 23 is a diagram illustrating an example of an expiration time limit extension request.

FIG. 24 is a flowchart illustrating an example of expiration time limit extension processing.

### DESCRIPTION OF THE EMBODIMENTS

However, in the configuration discussed in Japanese Patent Application Laid-Open No. 2017-21407, it is necessary to keep the information processing apparatus in which the setting operation has been first completed in the state of being connected to a network, and securing a space for locating the information processing apparatus also becomes an issue. Therefore, a system is conceivable which causes a local server in an intranet environment located in an office or factory to manage content data, such as firmware, having a large file size and, during a setting operation, acquires the content data from the local server.

On the other hand, since, for example, user information may be included in content data, when an acquisition request for setting data is acquired from an information processing apparatus, the source making the acquisition request is requested to be authenticated. The same applies to a case where the local server is caused to manage a part of content data, and, when the local server receives an acquisition request for content data, it is also necessary to request authentication from the source making the acquisition request.

However, requesting authentication again from the user who has executed authentication and has acquired setting data so as to acquire content data from the local server is inefficient.

Aspects of the present disclosure are generally directed to enabling the user to securely acquire content data from a local server while maintaining the user's operability in automatic setting processing.

Hereinafter, various exemplary embodiments, features, and aspects of the disclosure will be described in detail with reference to the drawings.

### <System Configuration>

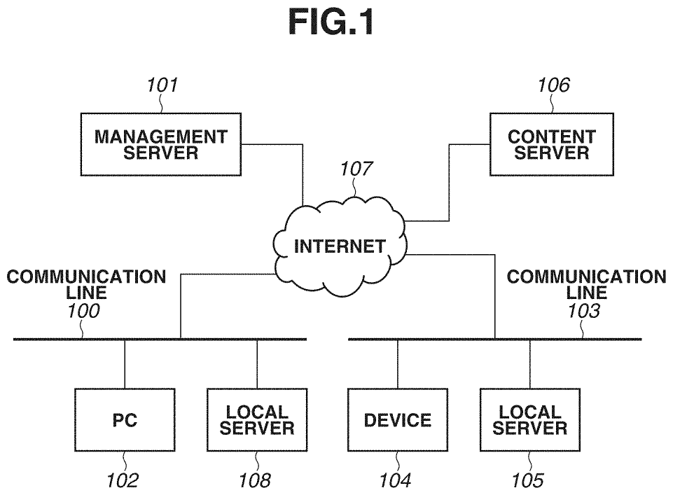

FIG. 1 is a diagram illustrating an example of a system configuration of an information processing system according to a first exemplary embodiment.

A communication line 100 is a local area network (LAN) to which a personal computer (PC) 102 and a local server 108 are connected. A management server 101, which is a server on the Internet 107, manages setting data used for a device 104 to perform automatic setting processing. The PC 102 is connected to the management server 101, and performs generation or editing of setting data. To enable generation or editing of setting data, user authentication (inputting of, for example, a user identifier (ID) and a password) by a person who generated the setting data is executed. Moreover, the local server 108 is also connected to the communication line 100.

A communication line 103 is also a LAN, as with the communication line 100, to which the device 104 and a local server 105 are connected. The device 104 is an information processing apparatus which acquires setting data from the management server 101 and automatically executes a setting operation. Specific examples of the information processing apparatus include a digital multifunction peripheral. To enable executing a setting operation, device authentication described below is executed.

Each of local servers 105 and 108 is a server for caching content data retained by a content server 106 to an intranet. The device 104 is able to reduce a content acquisition time or decrease a network load by acquiring content data not from the content server 106 but the local server 105 or 108. The content data as used herein refers to software, such as application or firmware, which is to be set to the device 104.

The content server 106, which is a server on the Internet 107, manages firmware or an application for the device 104 and enables downloading thereof via the Internet 107. The communication lines 100 and 103, the management server 101, and the content server 106 are interconnected in such a way as to be able to communicate with each other via the Internet 107. Usually, a proxy server or firewall (not illustrated) is installed between the communication lines 100 and 103 and the Internet 107.

While, in the following exemplary embodiments, a case where two local servers (105 and 108) are present in an internal network system in which the device 104 is present is described as an example, the number of local servers can be one and is not specifically limited. Moreover, without the communication line 100 and the communication line 103 being separately provided, the PC 102, the device 104, and the local servers 105 and 108 can be connected to the same LAN.

### <Hardware Configuration>

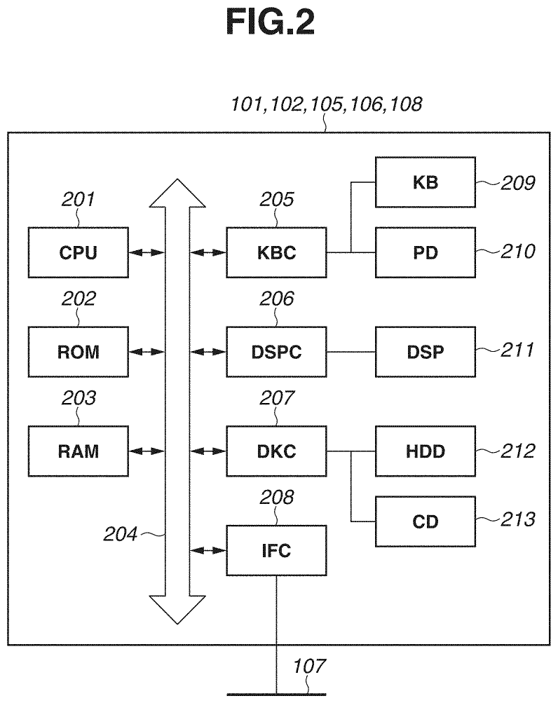

FIG. 2 is a diagram illustrating an example of a hardware configuration of each of the management server 101, the PC 102, the content server 106, and the local servers 105 and 108. For example, the function of each apparatus is implemented by a central processing unit (CPU) of each apparatus performing processing based on a program stored in, for example, a hard disk drive (HDD) of each apparatus. While, in FIG. 2, the management server 101 is taken as an example for description, the other apparatuses included in the information processing system also have a similar hardware configuration.

In the management server 101, a program for automatic setting software is stored in an HDD 212.

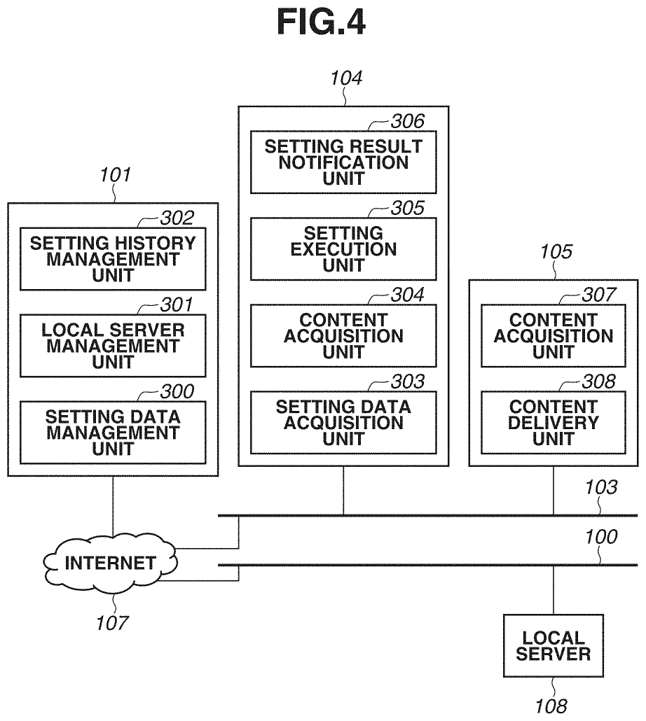

A CPU 201 performs control of the entire management server 101. A software configuration of the management server 101 illustrated in FIG. 4 and processing in flowcharts described below are implemented by the CPU 201 reading out a program recorded on the HDD 212 onto, for example, a random access memory (RAM) 203 and executing the program.

Programs of Basic Input/Output System (BIOS) and a boot program are stored in a read-only memory (ROM) 202.

The RAM 203 functions as, for example, a main memory or work area for the CPU 201.

A keyboard controller (KBC) 205 controls inputting of instructions coming from, for example, a keyboard (KB) 209 and a pointing device (PD) 210.

A display controller (DSPC) 206 controls displaying performed by a display (DSP) 211.

A disk controller (DKC) 207 controls access to storage devices such as a hard disk drive (HDD) 212 and a compact disc ROM (CD) 213. For example, a boot program, a program for an operating system, a database, an automatic setting program, and data are stored in, for example, the HDD 212 and the CD-ROM (CD) 213.

An interface controller (IFC) 208 performs data communications with the PC 102, the device 104, and the content server 106 via the Internet 107. These constituent elements are arranged on a system bus 204.

The automatic setting program according to the first exemplary embodiment can be supplied in the form of being stored in a storage medium such as a CD-ROM. In that case, the program is read from a storage medium such as the CD 213 illustrated in FIG. 2 and is then installed on the HDD 212.

### <Hardware Configuration of Device>

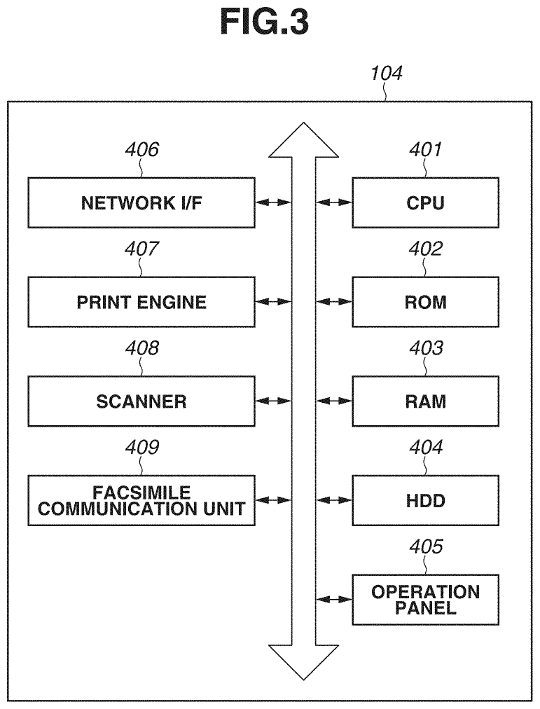

FIG. 3 is an explanatory diagram illustrating an example of a hardware configuration of the device 104. Specific examples of the device 104 include an image forming apparatus equipped with, for example, a printing function, a scanning function, and a network communication function.

A CPU 401 performs control of the entire image forming apparatus.

A ROM 402 stores a print processing program, which is executed by the CPU 401, and font data.

A RAM 403 is used as a work area for the CPU 401, as a receive buffer, and for image rendering.

A hard disk drive (HDD) 404 records thereon, for example, programs and setting values for the device 104.

An operation panel 405 is composed of various switch buttons, a touch panel, and a liquid crystal display unit for message displaying. The CPU 401 is able to change setting values for the device 104 stored in, for example, the HDD 404 according to an operation performed by the user via the operation panel 405.

A network interface (I/F) 406 is used to connect to a network.

A print engine 407 is an engine of a printer which performs printing on a recording sheet of paper.

A scanner 408 is used to read an original.

A facsimile communication unit 409 is a communication unit used to perform facsimile transmission and reception.

A software configuration of the device 104 illustrated in FIG. 4 and processing in the flowcharts described below are implemented by the CPU 401 performing processing based on programs stored in the ROM 402 or the HDD 404.

### <Software Configurations of Management Server, Device, and Local Server>

FIG. 4 is a diagram illustrating examples of software configurations of the management server 101, the device 104, and the local server 105 or 108. Since the local server 105 and the local server 108 have almost the same software configuration, in FIG. 4, the local server 105 is described as a representative.

The management server 101 includes a setting data management unit 300, a local server management unit 301, and a setting history management unit 302. The setting data management unit 300 manages setting data required for setting the device 104. The local server management unit 301 manages information about the local servers 105 and 108. The setting history management unit 302 manages a history (setting history) in which setting of the device 104 was executed with use of setting data managed by the management server 101.

Setting data and local server information are managed for every organization, and the user in an organization is not able to refer to data about another organization. On the other hand, the users belonging to the same organization are able to refer to data about that organization. The organization as used in the first exemplary embodiment is a unit of logical group of users who use an automatic setting service. The organization can be generated for every base (business establishment) of a company, or a plurality of bases can be treated as the same organization with an emphasis on the ability to refer to data. In the first exemplary embodiment, the local servers 105 and 108 are assumed to be managed by the local server management unit 301 as local servers belonging to the same organization.

The device 104 includes a setting data acquisition unit 303, a content acquisition unit 304, a setting execution unit 305, and a setting result notification unit 306. The setting data acquisition unit 303 acquires setting data and content data acquisition destination information attached thereto from the management server 101 via the Internet 107. The content acquisition unit 304 determines an acquisition destination of content data based on information acquired by the setting data acquisition unit 303 and then acquires the content data.

The setting execution unit 305 executes setting processing for the device 104 with use of the setting data acquired by the setting data acquisition unit 303 and the content data acquired by the content acquisition unit 304. The setting result notification unit 306 notifies the management server 101 via the Internet 107 of a result of the setting processing executed by the setting execution unit 305.

The local server 105 (or the local server 108) includes a content acquisition unit 307 and a content delivery unit 308. The content acquisition unit 307 acquires content data from the management server 101. While, in the first exemplary embodiment, the content data as used here is assumed to be, for example, firmware with a large file size, content data which is acquired by the content acquisition unit 307 is not limited to the one with a large file size. The content delivery unit 308 delivers content data in response to a request from the device 104.

The device 104 and the management server 101 perform communications with use of a technique such as Representational State Transfer (REST) or Simple Object Access Protocol (SOAP).

### <Setting Data>

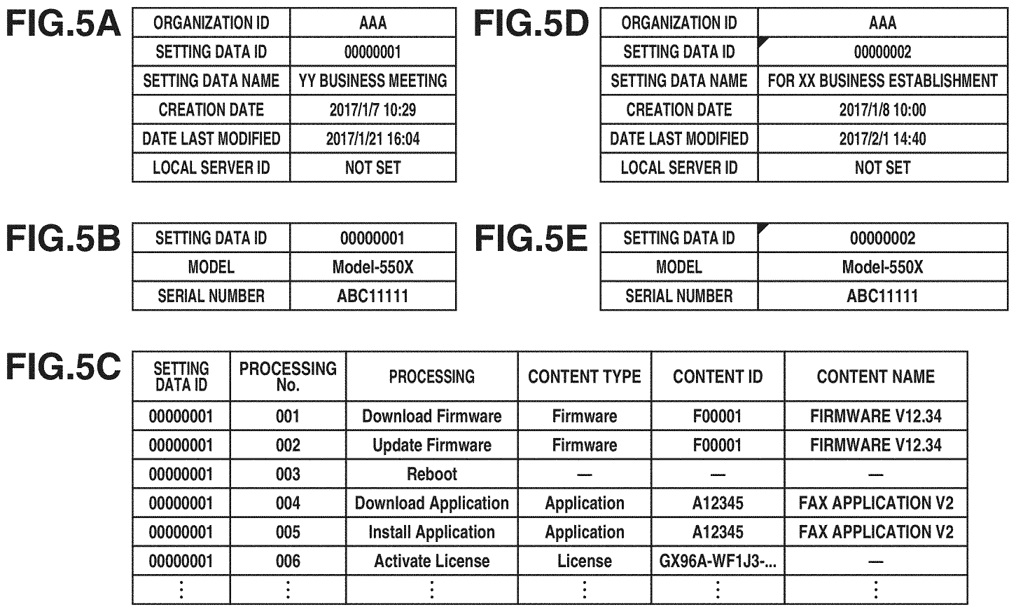

FIGS. 5A, 5B, 5C, 5D, and 5E are diagrams illustrating examples of setting data which the setting data management unit 300 (management server 101) manages. The user such as a sales representative accesses the management server 101 via the PC 102 to perform generation, editing, or deletion of setting data. Furthermore, since FIG. 5D is the same as FIG. 5A and FIG. 5E is the same as FIG. 5B with respect to items, FIG. 5A and FIG. 5B are described as representatives.

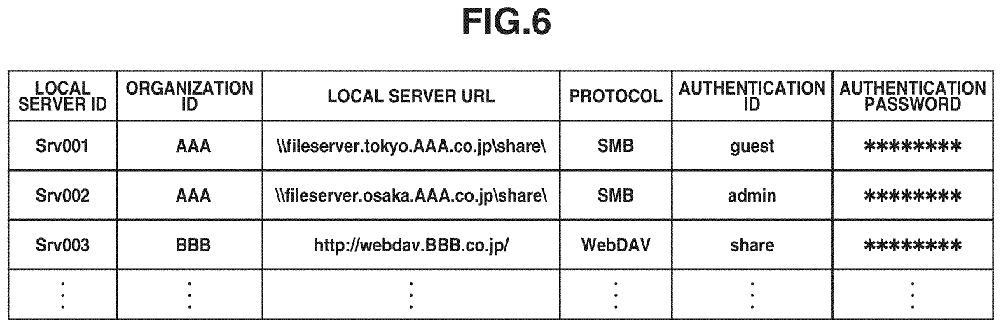

FIG. 5A illustrates attribute values of setting data and additional information. In the example illustrated in FIG. 5A, an “organization ID”, a “setting data ID”, “a setting data name”, a “creation date” and a “date last modified” of setting data, and a “local server ID” of a local server serving as an acquisition destination of content data required for setting processing are retained. Details of the local server ID are described below with reference to FIG. 6. Information illustrated in FIG. 5A out of the setting data is referred to as “setting meta-information”.

FIG. 5B illustrates information for identifying the device 104 to which setting data is to be applied. In the example illustrated in FIG. 5B, a “setting data ID” and a “model” and a “serial number” of the device targeted for setting of setting data are retained. Information illustrated in FIG. 5B out of the setting data is referred to as “setting target information”.

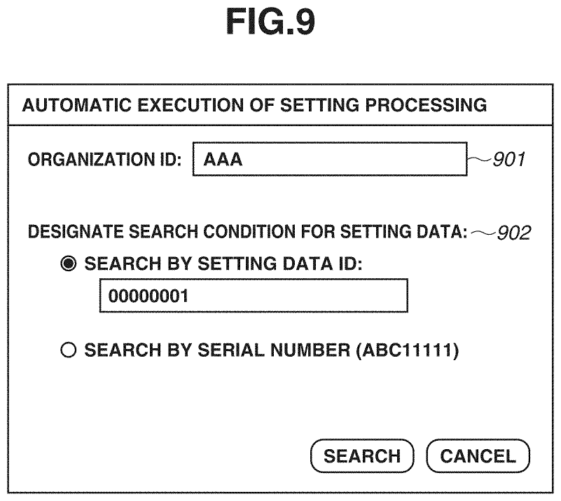

In a case where the serial number of a device targeted for a setting operation is “ABC11111”, the setting data ID “00000001” is specified with reference to FIG. 5B. With reference to FIG. 5A, the organization ID “AAA” is specified based on the setting data ID, and is then compared with an organization ID which is input to a screen (FIG. 9) used to search for setting data.

Depending on devices, as a result of referring to setting data illustrated in FIGS. 5A to 5C, a plurality of pieces of setting data may be specified. A configuration in which a plurality of pieces of setting data is associated with one device is specifically, for example, a case where setting data was generated in a step-by-step manner according to a request from a customer. With reference to FIGS. 5B and 5E, two setting data IDs are specified based on the serial number “ABC11111”, and, with reference to FIGS. 5A and 5D, organization IDs to which the respective devices belong are specified.

FIG. 5C illustrates information indicating the contents of setting processing operations, which the device 104 performs, and the sequence thereof. In the example illustrated in FIG. 5C, a “setting data ID”, a “processing No.”, which is the order of processing, “processing”, which is the content of processing, a “content type”, which is the type of content data used for processing, a “content data ID”, which is an identifier of content data, and a “content name”, which is the name of content data, are retained. Information illustrated in FIG. 5C out of the setting data is referred to as “setting processing information”.

With reference to FIG. 5C, for example, the content of processing which is to be performed first by the device is downloading of firmware, in which the “processing No.” is “001”, and the content of processing which is to be performed secondly by the device is application (updating) of firmware, in which the “processing No.” is “002”.

Since pieces of data illustrated in FIGS. 5A to 5E are associated with the respective setting data IDs, the model and serial number of a device targeted for setting do not need to be specified in the setting data. As a result, the setting data becomes data that is usable in a general-purpose manner with respect to a plurality of models or a plurality of devices of the same model.

While, in FIGS. 5A to 5E, the setting data is illustrated in the state of being divided into three tables for setting meta-information, setting target information, and setting processing information, the number of tables with which the respective pieces of information are managed is not limited as long as the respective pieces of information are in the state of being associated with each other.

Moreover, while pieces of information illustrated in FIGS. 5A, 5B, 5D, and 5E are referred to when the management server 101 identifies the setting data and are, therefore, assumed to be in the form of a database (table), pieces of information illustrated in FIG. 5C are referred to by the device 104 in acquiring content data, so that the content illustrated in FIG. 5C is not referred to by the management server 101. Thus, pieces of information illustrated in FIG. 5C do not need to be in the form of a table, but can be data of the file format.

### <Local Server Information>

FIG. 6 is a diagram illustrating an example of local server information which is managed by the local server management unit 301 (the management server 101). The local server information is registered by, for example, a PC, which is connected to the local server 105 or 108 or the communication line 103, accessing the management server 101.

In the example illustrated in FIG. 6, a “local server ID”, an “organization ID”, a “local server Uniform Resource Locator (URL)”, and a “protocol” and authentication information (an “authentication ID” and an “authentication password”), which are used for accessing a local server, are retained. More specifically, with respect to an organization of the organization ID “AAA”, local server information about two local servers of the local server IDs “Srv001” and “Srv002” is registered. In the present exemplary embodiment, the local server 105 is equivalent to that of the local server ID “Srv001” and the local server 108 is equivalent to that of the local server ID “Srv002”. The organization ID is an example of identification information about an organization.

Since, as illustrated in FIG. 6, the local server information includes confidential information for each organization, such as a local server URL or authentication information (an authentication ID or authentication password), the device 104 belonging to an organization is managed in such a way as to be able to use only local server information about the organization itself and not to be able to use local server information about another organization.

### <Automatic Setting Processing>

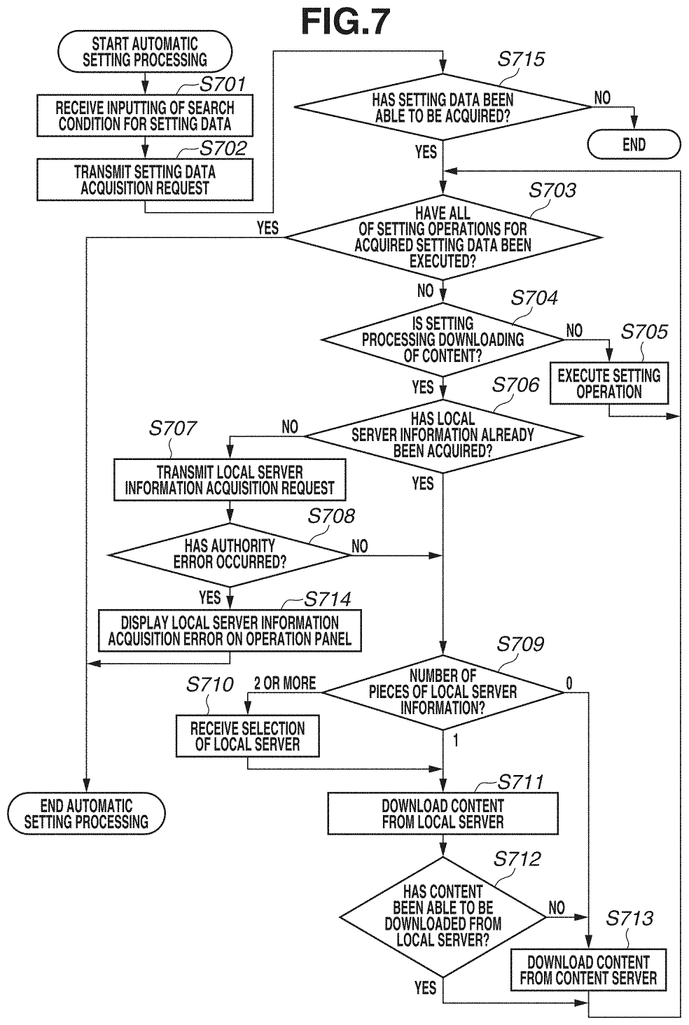

FIG. 7 is a flowchart illustrating an example of automatic setting processing which the setting execution unit 305 of the device 104 executes. Automatic setting processing which is mainly executed by the management server 101 is described below.

In step S701, the setting execution unit 305 receives inputting of a search condition for setting data from the user via the operation panel 405. FIG. 9 illustrates an example of a screen which is displayed on the operation panel 405 at that time.

An input item 901 is a form into which to input an identifier of an organization which possesses setting data. An input item 902 is a form into which to input a search condition for setting data. In the example illustrated in FIG. 9, the selectable search methods for setting data include searching by a setting data ID and searching by a serial number of the device 104. In a case where a setting data ID has been input into the input item 902, setting data which is managed by the management server 101 is directly searched for. In a case where “search by serial number (ABC11111)” has been selected in the input item 902, if a setting data ID “00000001” is specified with reference to FIG. 5B and it is confirmed that an organization ID (FIG. 5A) specified by the setting data ID coincides with the organization ID input into the input item 901 illustrated in FIG. 9, setting data is identified with reference to FIG. 5C.

The configuration of causing the user to select a search condition for setting data is not limited to the method illustrated in FIG. 9. A plurality of different search conditions can be displayed in the screen illustrated in FIG. 9, or screens used for selecting the respective search conditions can be displayed one by one in a step-by-step manner.

In this way, to make a setting operation more efficient, the information processing system employs not user authentication, which is executed with the device 104, but device authentication, which is executed by setting data being specified. Advantages of employing device authentication include reducing a management cost for user authentication information or preventing a time loss caused by requiring user authentication in each setting operation. Moreover, it is desirable that the setting data ID be an ID that cannot be easily guessed and has a large number of digits. As a result, it is not necessary to manage authentication information about an installation operator, so that an installation operation can be efficiently performed.

The description refers back to FIG. 7. In step S702, the setting execution unit 305 transmits, to the management server 101, a request for acquiring setting data matching the condition designated in step S701 via the setting data acquisition unit 303.

In step S715, the setting data acquisition unit 303 determines whether setting data has been able to be acquired from the management server 101. If it is determined that setting data has been able to be acquired (YES in step S715), the processing proceeds to step S703, and, if it is determined that setting data has not been able to be acquired (NO in step S715), the automatic setting processing ends. The acquired setting data is transmitted from the setting data acquisition unit 303 to the setting execution unit 305.

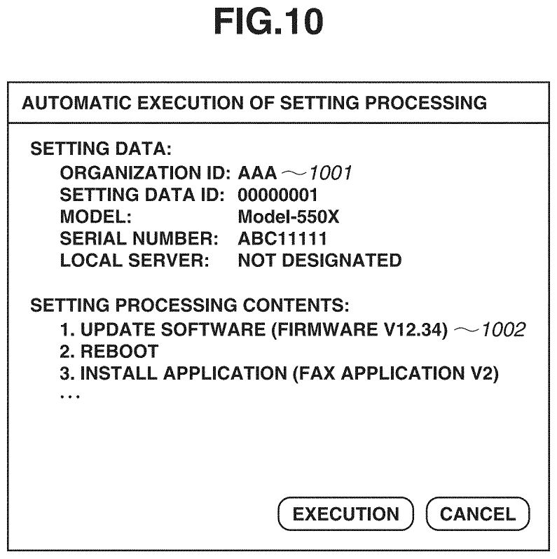

In step S703, the setting execution unit 305 determines whether a series of setting processing operations included in the acquired setting data has been executed. FIG. 10 illustrates an example of setting data which is acquired when the organization ID “AAA” and the setting data ID “00000001” have been input in the search screen illustrated in FIG. 9. Information 1001 includes setting meta-information (FIG. 5A) and setting target information (FIG. 5B) which have been received as a result of processing performed in step S702. Information 1002 is setting processing information included in the setting data which has been received as a result of processing performed in step S702. When the setting operator confirms the setting processing contents and then presses an execution button in the screen illustrated in FIG. 10, the setting execution unit 305 performs processing operations in step S703 and subsequent steps.

The description refers back to FIG. 7. If, in step S703, it is determined that there is an unexecuted setting processing operation (NO in step S703), the processing proceeds to step S704, and, if it is determined that all of the setting processing operations have been executed (YES in step S703), the automatic setting processing ends. The setting execution unit 305 of the device 104 stores, in the RAM 403 or the HDD 404, setting data and an execution status of each setting processing operation designated by the setting data, thus managing how far the setting operations have been executed. The setting execution unit 305 executes each setting processing operation while referring to the execution status, so that the setting processing is finally completed.

In step S704, the setting execution unit 305 determines whether the setting processing operation which has been determined to be unexecuted in step S703 and which is to be executed next is downloading of content data. If it is determined that the next setting processing operation is downloading of content data (YES in step S704), the processing proceeds to step S706. If it is determined that the next setting processing operation is other than downloading of content data (NO in step S704), the processing proceeds to step S705, in which the setting execution unit 305 executes a setting processing operation described in the setting data.

With regard to data illustrated in FIG. 5C, if the setting execution unit 305 has determined that the setting processing “Download Firmware” of processing No. “001” is unprocessed, the processing proceeds to step S706. On the other hand, the setting processing “Reboot” of processing No. “003” is unexecuted, the processing proceeds to step S705.

After, in step S704, it is determined that the next setting processing operation is downloading of content data, then in step S706, the setting execution unit 305 determines whether local server information has already been acquired from the management server 101. The method of acquiring local server information includes a method of acquiring the local server information together with the setting data in step S702 and a method of acquiring the local server information in step S707 described below. If it is determined that local server information has already been acquired (YES in step S706), the processing proceeds to step S709, and, if it is determined that local server information has not yet been acquired (NO in step S706), the processing proceeds to step S707.

If, in step S706, it is determined that local server information has not yet been acquired, then in step S707, the setting execution unit 305 transmits an acquisition request for local server information to the management server 101 via the content acquisition unit 304. The acquisition request includes a serial number and an organization ID which has been temporarily stored in the device 104 by an input operation in step S701.

In step S708, the setting execution unit 305 determines whether an authority error has been acquired from the management server 101 as a response to the transmission performed in step S707. The authority as used here refers to an authority which is given by an organization ID and a serial number being input to the setting history with the successful search for setting data taken as a trigger and which is required for the device 104 to acquire local server information. If it is determined that an authority error has been acquired (YES in step S708), the processing proceeds to step S714.

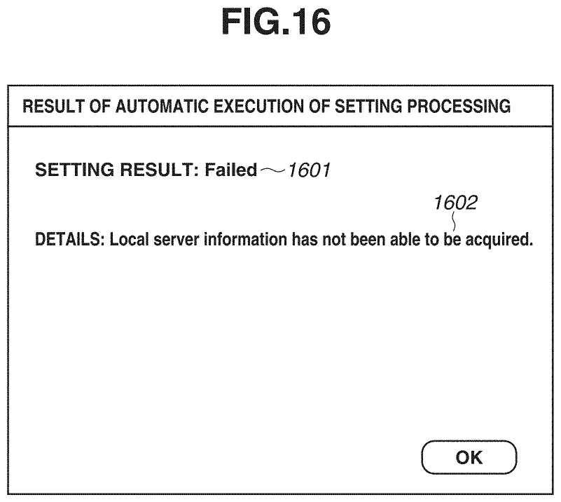

In step S714, the setting execution unit 305 displays, on the operation panel 405, information indicating that an authority error has occurred and the acquisition of local server information is, therefore, failed. FIG. 16 illustrates an example of an authority error which is displayed on the operation panel 405 of the device 104. Information 1601 indicates a setting result “Failed”, and information 1602 indicates the content of failure.

If, in step S708, it is determined that no authority error has occurred and local server information has been able to be normally received (including a case where the number of pieces of received local server information is zero) (NO in step S708), the processing proceeds to step S709.

In step S709, the setting execution unit 305 determines the number of pieces of local server information received from the management server 101. When the management server 101 transmits local server information to the device 104, information illustrated in FIG. 6 is referred to. If it is determined that the number of pieces of received local server information is two or more (2 OR MORE in step S709), the processing proceeds to step S710, if it is determined that the number of pieces of received local server information is only one (1 in step S709), the processing proceeds to step S711, and, if it is determined that the number of pieces of received local server information is zero (0 in step S709), the processing proceeds to step S713. In the case of the information illustrated in FIG. 6, since local server information associated with the organization ID “AAA” is “Srv001” and “Srv002”, the number of pieces of received local server information is two, so that the processing proceeds to step S710.

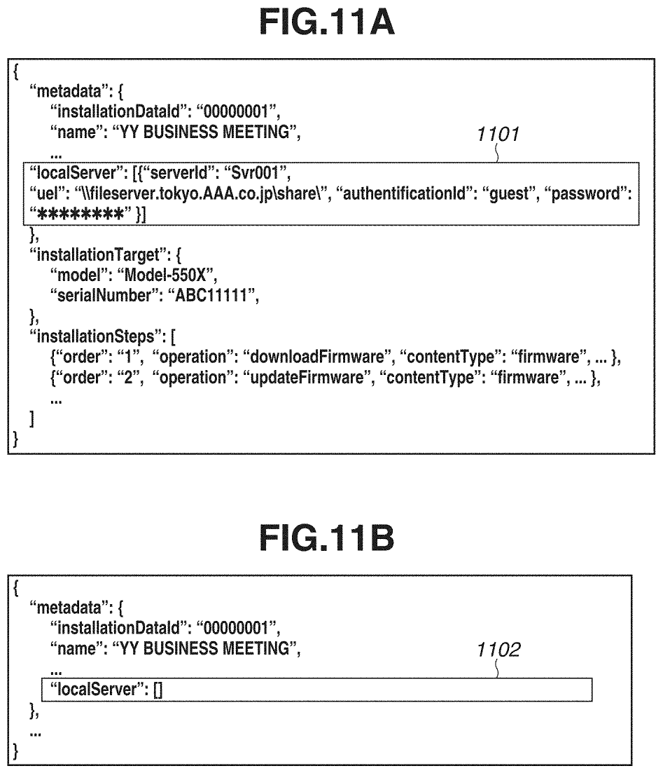

FIG. 11B illustrates an example of a response to the request transmitted in step S707 in a case where the number of pieces of received local server information is zero (in other words, in a case where no local server information is included in the response). It can be seen that no local server information is described in a local server information field 1102. A case where it is determined that the number of pieces of received local server information is zero means that pre-registration of local server information with the information illustrated in FIG. 6 was not performed.

FIG. 11A illustrates an example of a response to the request transmitted in step S707 in a case where the number of pieces of received local server information is one. Local server information designated in the setting data is described in a local server information field 1101 as a part of the setting meta-information. Specifically, for example, a local server ID and a local server URL such as those illustrated in FIG. 6 are included in the local server information.

Besides, the setting target information and the setting processing information are described in the response. Furthermore, in a case where, in step S709, it is determined that the number of pieces of received local server information is two or more, a plurality of pieces of local server information is included in the local server information field 1101.

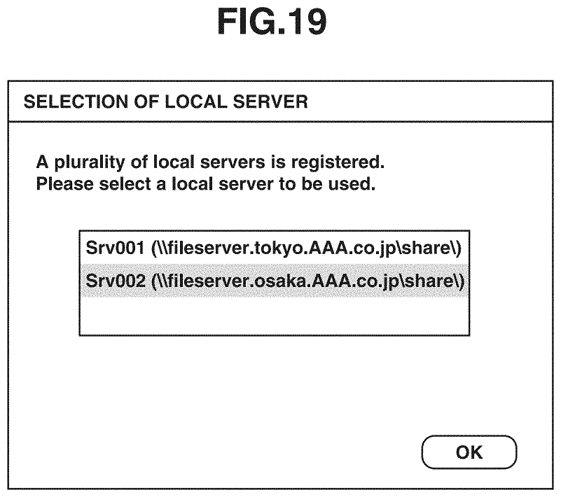

The description refers back to FIG. 7. In a case where it is determined that the number of pieces of acquired local server information is two or more, then in step S710, the setting execution unit 305 displays a plurality of pieces of local server information via the operation panel 405 and prompts the user to select local server information to be used for installation. FIG. 19 illustrates an example of a screen which is displayed on the operation panel 405 at that time. Since the organization ID “AAA” is input in the search screen for setting data illustrated in FIG. 9, local servers which are displayed in the screen illustrated in FIG. 19 are the local server 105 (local server ID: Srv001) and the local server 108 (local server ID: Srv002), which belong to the organization ID “AAA”.

In a case where, in step S709, it is determined that the number of pieces of acquired local server information is one, then in step S711, the setting execution unit 305 acquires content data from the designated local server via the content acquisition unit 304. Specifically, the setting execution unit 305 acquires, from the local server, content data corresponding to the content ID designated in the setting processing information illustrated in FIG. 5C. In the local server, files of content data are arranged in such a manner that content data can be identified by a content ID taken as a key.

Moreover, when transmitting an acquisition request for content to the local server in step S711, the content acquisition unit 304 transmits local server information to the local server. The local server, which has received the local server information, verifies authentication information (an authentication ID or an authentication password, or both of them) included in the local server information, and thus authenticates the device 104, which has transmitted the acquisition request for content.

In step S712, the setting execution unit 305 determines whether content data has been able to be acquired from the local server in step S711. If it is determined that content data has been able to be acquired (YES in step S712), the processing returns to step S703, and, if it is determined that content data has not been able to be acquired (NO in step S712), the processing proceeds to step S713.

In a case where content data has not been able to be acquired from the local server, then in step S713, the setting execution unit 305 acquires, via the content acquisition unit 304, content data not from the local server but from an external server such as the content server 106. Processing for acquiring content data based on the setting processing information illustrated in FIG. 5C can be equivalent to processing in step S711, or can be performed with use of a protocol such as REST or SOAP.

As a specific processing operation performed in step S713, external server information (content server information) which is previously managed by the management server 101 is referred to by the device 104. An example of content server information about the content server 106 is shown in Table 1.

TABLE 1
Example of Content Server Information

| | Authentication | Authentication |
|---|---|---|
| Content server URL | ID | password |
| http://cccc.dddd.co.jp/ | abc1234 | ******** |

The device 104 acquires content server information from the management server 101 and transmits the acquired content server information to the content server 106, thus acquiring content data, which has not been able to be acquired from the local server. At that time, the content server 106, which has received the content server information, authenticates the device 104 by verifying authentication information (an authentication ID or an authentication password, or both of them) included in the content server information, and then transmits content data to the device 104. Furthermore, depending on content data to be acquired, a configuration of allowing content data to be acquired from a content server without the use of authentication information (an authentication ID or an authentication password) can be employed.

In this way, in consideration of, for example, a network load applied when content data with a large file size is downloaded or a time required for such downloading, an acquisition request for content data is transmitted not to the content server 106 but to the local server. Only in a case where content data is not able to be acquired from the local server, the device 104 attempts to acquire content data from the content server 106.

Thus far is the automatic setting processing, and steps other than steps S701 and S710 are automatically performed without involvement from a user operation. Furthermore, to perform the automatic setting processing more efficiently, a configuration of causing the setting execution unit 305 to store information about a local server selected in processing in steps S706 to S710 and, in the automatic setting processing for the second and subsequent times, acquiring content data from the selected local server without involvement from a user operation can be employed.

### <Transmission Processing for Setting Data>

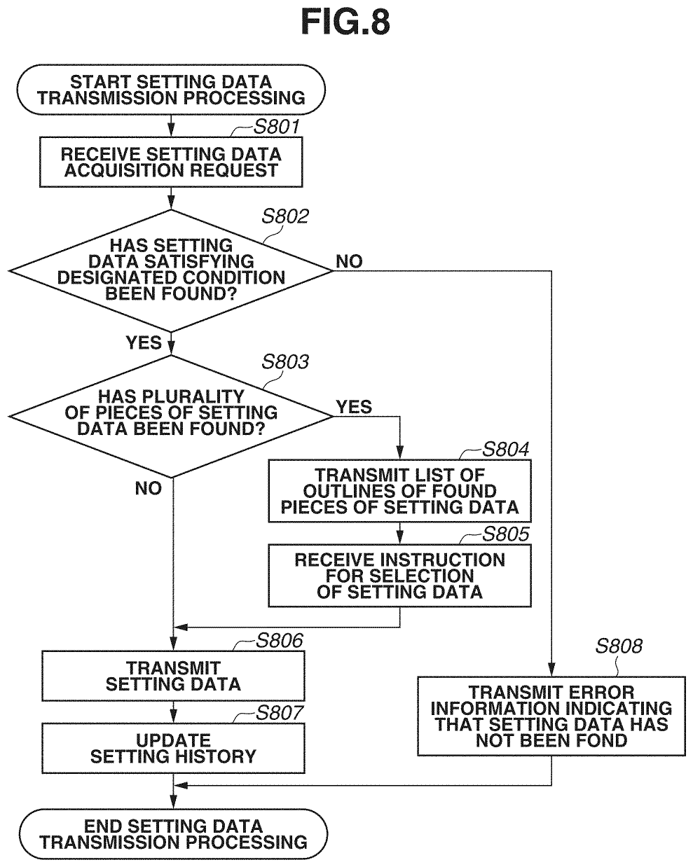

FIG. 8 is a flowchart illustrating setting data transmission processing which is performed by the management server 101. This processing is triggered by the setting data acquisition request transmitted from the device 104 and is mainly performed by the setting data management unit 300 of the management server 101.

In step S801, the setting data management unit 300 receives the setting data acquisition request from the setting data acquisition unit 303 of the device 104. The setting data acquisition request includes at least an organization ID and a setting data ID, or an organization ID and a serial number. The setting data acquisition request received in step S801 corresponds to a request which the device 104 transmits to the management server 101 in step S702. Furthermore, in both the case of searching for setting data by a setting data ID and the case of searching for setting data by a serial number, a serial number is transmitted from the device 104 to the management server 101.

In step S802, the setting data management unit 300 determines whether, among pieces of setting data retained by the management server 101, there is setting data satisfying the condition designated in the setting data acquisition request received in step S801. Specifically, in a case where the organization ID “AAA” and the setting data ID “00000001” have been designated in the screen illustrated in FIG. 9, the setting data management unit 300 searches the setting meta-information illustrated in FIG. 5B to determine whether there is a setting data ID coincident with the condition in an organization ID and a serial number of the transmission source for the request.

In the case of designating an organization ID and searching for setting data by the serial number “ABC1111” in the screen illustrated in FIG. 9, setting data IDs “00000001” and “00000002” are specified by the serial number. The specified setting data IDs and pieces of data illustrated in FIGS. 5A and 5D are used to specify the organization ID “AAA”, and it is confirmed that the specified organization ID “AAA” coincides with the organization ID “AAA” input to the screen illustrated in FIG. 9.

If it is determined by the setting data management unit 300 that there is setting data satisfying the transmitted condition (YES in step S802), the processing proceeds to step S803, and if it is determined that there is no setting data satisfying the transmitted condition (NO in step S802), the processing proceeds to step S808.

In step S803, the setting data management unit 300 determines whether a plurality of pieces of setting data has been found in step S802. If it is determined by the setting data management unit 300 that a plurality of pieces of setting data has been found (YES in step S803), the processing proceeds to step S804, and if it is determined that only one piece of setting data has been found (NO in step S803), the processing proceeds to step S806. As mentioned above, in the case of searching for setting data by a serial number, since there are two pieces of setting data coincide with the condition in the organization ID and the serial number, the processing proceeds to step S804.

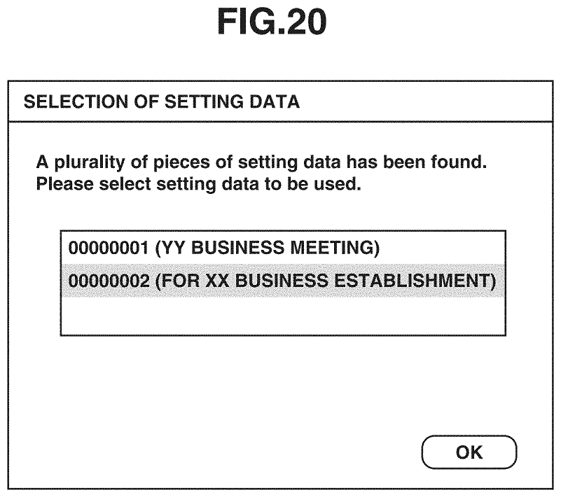

In step S804, to allow the user to select one of a plurality of pieces of setting data found in step S802, the setting data management unit 300 transmits a list of outlines of the found pieces of setting data (for example, setting data IDs and setting data names) to the device 104. The device 104 displays the received list of outlines of the found pieces of setting data on the operation panel 405. FIG. 20 illustrates an example of a display screen which is displayed at that time.

The screen illustrated in FIG. 20 is a display screen displayed in a case where setting data has been searched for by a serial number with use of the screen illustrated in FIG. 9. In a case where setting data has been searched for by a setting ID with use of the screen illustrated in FIG. 9, since setting data is uniquely specified, a screen in which a plurality of pieces of setting data is displayed as illustrated in FIG. 20 is never displayed. In the example illustrated in FIG. 20, two pieces of setting data are displayed to be selectable, in each of which a setting data ID and a setting data name are indicated.

The description refers back to FIG. 8. In step S805, the setting data management unit 300 receives information about the selected setting data via a user operation performed in the screen illustrated in FIG. 20. In step S806, the setting data management unit 300 transmits the setting data specified in step S802 or the setting data selected in step S805 to the device 104. In step S807, the setting data management unit 300 updates a setting history via the setting history management unit 302.

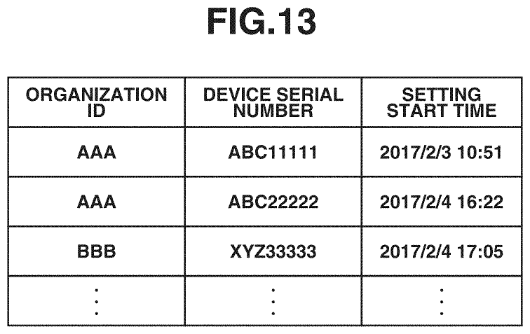

FIG. 13 illustrates an example of a setting history which is stored by the setting history management unit 302. The setting history includes records of an organization ID, a serial number, and a setting start time. The setting history management unit 302 records an organization ID and a serial number included in the setting data acquisition request (in step S801) in the setting history illustrated in FIG. 13. The setting start time is the time of day at which the setting history was updated in step S807. Unless setting data is transmitted to a device in step S806, the setting history is not updated. In other words, a record being present in the setting history means that searching for setting data which is to be set to the corresponding device was successful.

In a case where setting data satisfying the designated condition has not been found, then in step S808, the setting data management unit 300 transmits, to the device 104, error information indicating that there is no setting data satisfying the designated condition. Processing in step S808 is equivalent to NO in step S715 performed by the device 104. Thus far is the transmission processing for setting data.

### <Setting Data Acquisition Request>

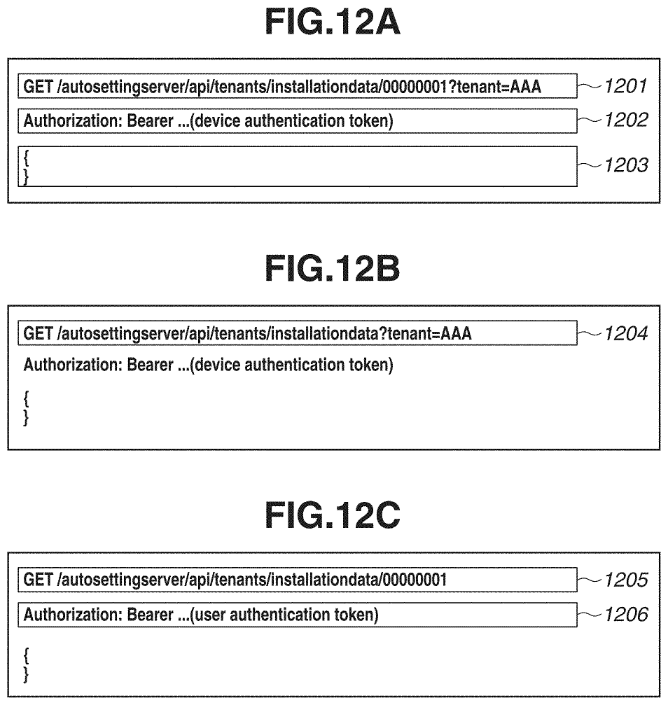

FIGS. 12A, 12B, and 12C illustrate examples of setting data acquisition requests each of which the device 104 transmits to the management server 101 in step S702. As also mentioned in the above description, the setting data acquisition request is transmitted to the management server 101 in response to a search condition for setting data being input to the search screen (FIG. 9) which is displayed in step S701.

The setting data acquisition request illustrated in FIG. 12A is transmitted when an organization ID and a setting data ID have been input as a search condition in the search screen illustrated in FIG. 9. Information 1201 represents a HyperText Transfer Protocol (HTTP) method and a request URL. The URL has a description of the setting data ID “00000001” as a path parameter and the organization ID “AAA” as a query parameter.

Information 1202 represents an HTTP header. In FIG. 12A, a token that is a result of device authentication (hereinafter referred to as a “device authentication token”) is included, and the management server 101 verifies the device authentication token and is thus able to acquire the serial number of the device 104 which has transmitted the request. However, since an organization ID is not able to be specified based on the device authentication token and the serial number specified thereby, an organization ID is designated as a query parameter in the information 1201. Information 1203 represents a body of the request.

The setting data acquisition request illustrated in FIG. 12B is transmitted when an organization ID and a serial number have been input as a search condition in the search screen illustrated in FIG. 9. A difference from the setting data acquisition request illustrated in FIG. 12A is that no setting data ID is designated as a parameter in information 1204. As mentioned above, the management server 101 is able to specify a serial number from a device authentication token.

The information processing system in the first exemplary embodiment is described on the premise of device authentication. However, user authentication may be performed at the device 104, and an example of a setting data acquisition request transmitted from the device 104 to the management server 101 at that time is illustrated in FIG. 12C. A difference from the setting data acquisition request illustrated in FIG. 12A is that no organization ID is designated as a query parameter in information 1205. Information 1206 includes a token which is a result of user authentication (hereinafter referred to as a “user authentication token”), and the management server 101 is able to uniquely identify the user by verifying the user authentication token. Additionally, since the management server 101 is also able to identify an organization ID with which the user is associated, a configuration in which no organization ID is designated at the URL in the information 1205 and the inputting of an organization ID on a search screen for setting data is not requested can be employed.

Furthermore, the above-mentioned user authentication or device authentication can be performed with use of a known technique such as OAuth when the device 104 starts making connection to the management server 101 (not illustrated).

Moreover, the setting data acquisition requests illustrated in FIGS. 12A to 12C can be transmitted from the PC 102 to the management server 101 so as to write setting data onto an external storage device such as a Universal Serial Bus (USB) memory. In the case of transmitting, for example, a request for acquiring and editing setting data from the PC 102 to the management server 101, since the user performs user authentication via a web browser of the PC 102, the request has the same form as that of the request illustrated in FIG. 12C.

Moreover, FIG. 12A to 12C illustrate examples of GET requests, and all of the pieces of information required by the management server 101 are included in each of the information 1201 and the information 1202, so that, in the first exemplary embodiment, the body (a portion described in { }) of each request only needs to be blank.

### <Local Server Information Acquisition Request>

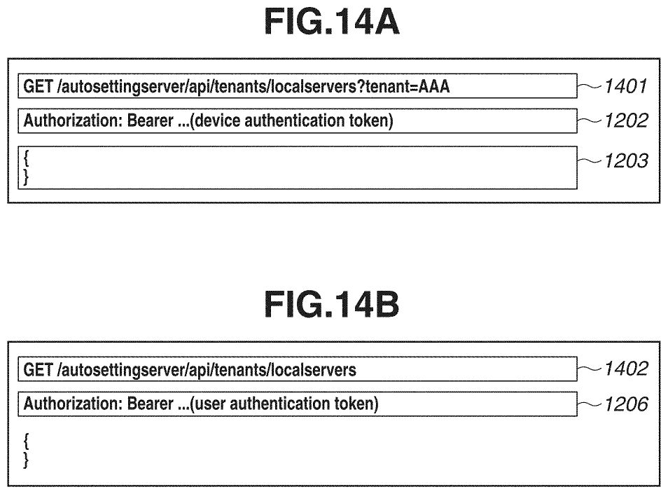

FIGS. 14A and 14B are explanatory diagrams illustrating examples of local server information acquisition requests each of which the device 104 transmits to the management server 101 in step S707. Portions similar to those illustrated in FIGS. 12A to 12C are assigned the respective same reference numerals, and are, therefore, omitted from description herein.

FIG. 14A illustrates an example of a local server information acquisition request which the device 104, which has performed device authentication, transmits. Information 1401 represents an HTTP method and a request URL. In the URL, the organization ID “AAA” is designated as a query parameter. A difference from the setting data acquisition request illustrated in FIG. 12A is that no setting data ID is included as a path parameter in the URL. Since local server information is managed for each organization as illustrated in FIG. 6, the local server information acquisition request does not need to include a setting data ID.

FIG. 14B illustrates an example of a local server information acquisition request which the device 104, which has performed user authentication, transmits. While, in the information processing system, usually, the device 104 performs not user authentication but device authentication from the viewpoint of operation efficiency, naturally, user authentication can be performed at the device 104, and, in that case, the local server information acquisition request has such a form as that illustrated in FIG. 14B. A difference from the local server information acquisition request illustrated in FIG. 14A is that no organization ID is designated as a query parameter in information 1402. This is because an organization ID is identified by the management server 101 verifying the authentication token (information 1206).

### <Local Server Information Transmission Processing>

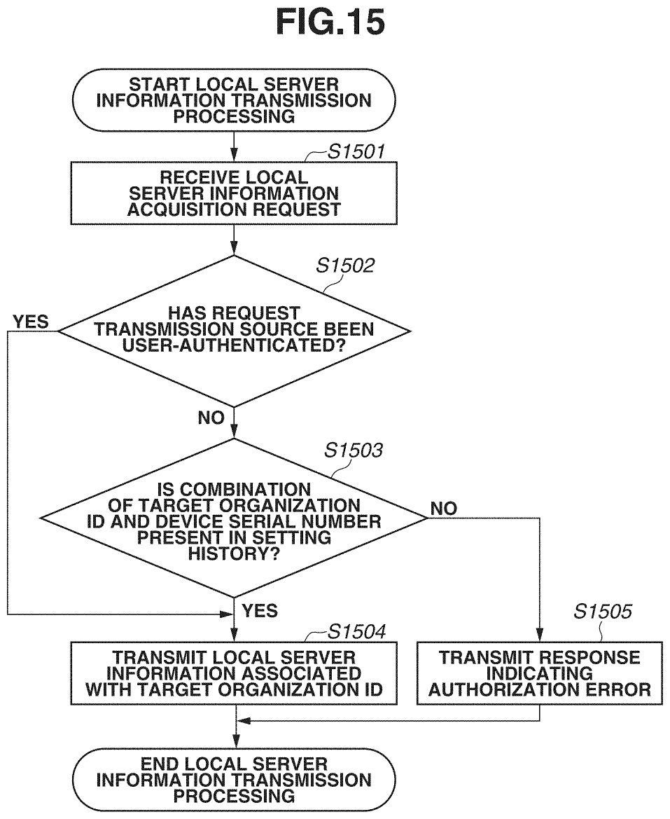

FIG. 15 is a flowchart illustrating an example of local server information transmission processing, which is performed by the management server 101. Starting of this processing is triggered by the management server 101 having acquired the local server information acquisition request in step S707.

In step S1501, the local server management unit 301 receives the local server information acquisition request from the device 104.

In step S1502, the local server management unit 301 determines whether the transmission source of the local server information acquisition request received in step S1501 has been user-authenticated. Specifically, if the local server information acquisition request has the same form as that illustrated in FIG. 14A, the local server management unit 301 determines that the request transmission source has not been user-authenticated (NO in step S1502) and the processing then proceeds to step S1503, and, if the local server information acquisition request has the same form as that illustrated in FIG. 14B, the local server management unit 301 determines that the request transmission source has been user-authenticated (YES in step S1502) and the processing then proceeds to step S1504.

A configuration conceivable to be a situation in which the transmission source of the local server information acquisition request has been user-authenticated is a configuration in which the creator such as a sales representative generates setting data. The creator is able to access the management server 101 by user authentication to make an acquisition request for local server information.

In step S1503, the local server management unit 301 identifies an organization ID and a serial number from the request illustrated in FIG. 14A, and then determines whether a combination of the organization ID and the serial number is present in the setting history illustrated in FIG. 13. In the present example, the local server management unit 301 identifies the organization ID “AAA” from the request illustrated in FIG. 14A, and, if it is determined that a combination of the organization ID “AAA” and a serial number identified from the token is present in the setting history (FIG. 13) (YES in step S1503), the processing proceeds to step S1504, and, if the combination is not present (NO in step S1503), the processing proceeds to step S1505.

In step S1504, the local server management unit 301 acquires local server information associated with the organization ID identified from the local server information acquisition request and then transmits the acquired local server information to the device 104. Specifically, the local server management unit 301 transmits, among pieces of local server information illustrated in FIG. 6, only local server information the organization ID of which matches the identified organization ID to the device 104. In the present example, since the organization ID “AAA” is input in the search screen for setting data (FIG. 9) and searching for setting data is successful, pieces of local server information about the local server IDs “Srv001” and “Srv002” illustrated in FIG. 6 are transmitted to the device 104.

In the first exemplary embodiment, local server information which is transmitted from the management server 101 to the device 104 is assumed to include at least authentication information and a local server URL. The authentication information as used herein is only an authentication ID or both an authentication ID and an authentication password. Which authentication information to transmit to the device 104 or, in the first place, whether to transmit authentication information differs depending on a protocol with which the device 104 accesses the local server 105 or the type of content data to be acquired.

For example, in a case where the protocol is the File Transfer Protocol (FTP), since the authentication password is an e-mail address of the user, only the authentication ID is transmitted as authentication information to the device 104. Moreover, a configuration in which, depending on the type of content data, authentication information is not used (the value of authentication information is made in blank) when content data is acquired from a local server can be employed.

If, in step S1503, it is determined that a combination of the organization ID and the serial number identified from the request is not present in the setting history, then in step S1505, the local server management unit 301 considers the local server information acquisition request received in step S1501 as unauthorized and thus transmits a response indicating an authorization error to the device 104.

Furthermore, since, according to the flowchart of FIG. 7, the management server 101 stores the setting history during proceeding from step S702 to step S703, the result of determination in step S1503 in the flowchart of FIG. 15, which is performed in conjunction with step S707, is normally YES, so that step S1505 is never performed. However, if step S707 is performed while step S702 is not performed due to, for example, a local server information acquisition request illustrated in FIG. 14A or 14B being falsified, step S1505 would be performed, so that a response indicating an authorization error is transmitted to the transmission source of the local server information acquisition request.

Thus far is the local server information transmission processing.

### <Outline of Automatic Setting Processing>

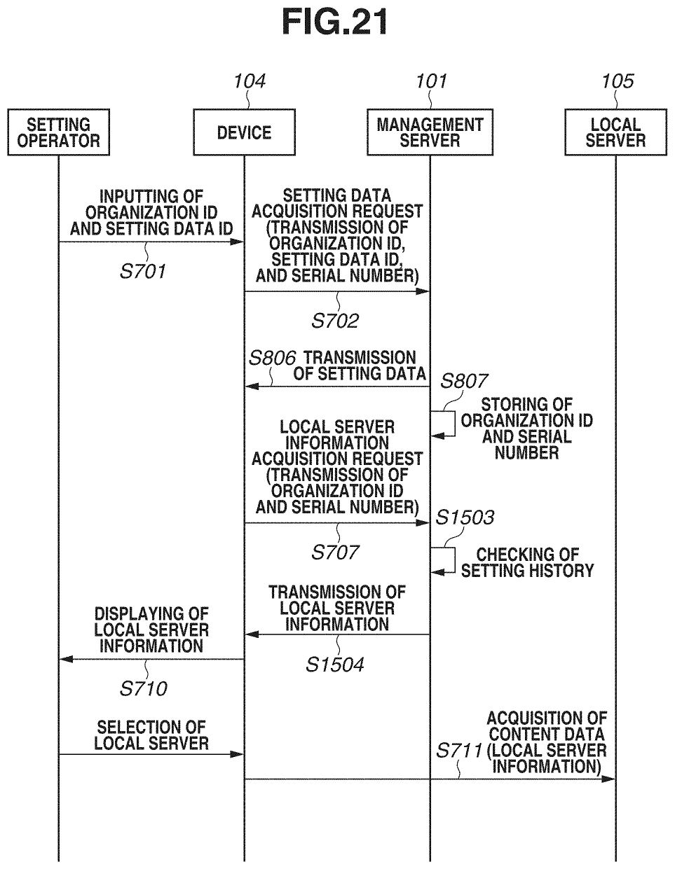

FIG. 21 is a sequence diagram illustrating an example of processing for an automatic setting operation using a local server. The same step numbers as those used in the above-described flowcharts are also used.

In steps S701 and S702, the organization ID and the setting data ID or only the organization ID (serial number), which the setting operator has input via the device 104, is transmitted to the management server 101. In step S806, device authentication is performed with use of the transmitted information, and, if device authentication is successful, setting data is transmitted to the device 104. In step S807, in response to the device authentication being successful, the organization ID and the serial number are stored in the setting history.

In step S707, the device 104, which has received the setting data, transmits an acquisition request for local server information to the management server 101. In step S1503, the management server 101, which has received the acquisition request for local server information, refers to the setting history and determines whether searching for the setting data is successful in step S807.

If it is determined that searching for the setting data is successful, then in step S1504, the management server 101 transmits local server information as a response to the request transmitted in step S707. In step S710 to step S711, in a case where a plurality of pieces of local server information is transmitted as a response, the user selects a local server, and the device 104 acquires content data from the selected local server 105. Thus far is the outline of automatic setting processing in the first exemplary embodiment.

According to the first exemplary embodiment, a management server manages local server information for each organization and determines a local server which is usable for automatic setting processing for a device, so that, even in a case where the building situation of a local server differs for each organization, acquiring content data with use of an intranet enables efficiently performing setting processing.

Moreover, determining whether to transmit a response to a local server information acquisition request with use of a setting history stored at the time of reception of a setting data acquisition request enables securely transmitting local server information without lowering a setting operation efficiency with respect to a device which has not executed user authentication.

In a case where setting data is once searched for and a setting history is indefinitely valid, as long as a local server information acquisition request is able to be transmitted to the management server 101, local server information would be acquired, so that the risk on security increases. In a second exemplary embodiment, a solution for solving such an issue is described.

In the second exemplary embodiment, configurations illustrated in FIG. 1 to FIG. 6, FIG. 8 to FIGS. 12A to 12C, FIGS. 14A and 14B, FIG. 16, and FIG. 19 to FIG. 21 are the same as those in the first exemplary embodiment, and portions similar to those in the first exemplary embodiment are assigned the respective same reference characters and are, therefore, omitted from description. Hereinafter, differences from the first exemplary embodiment are mainly described.

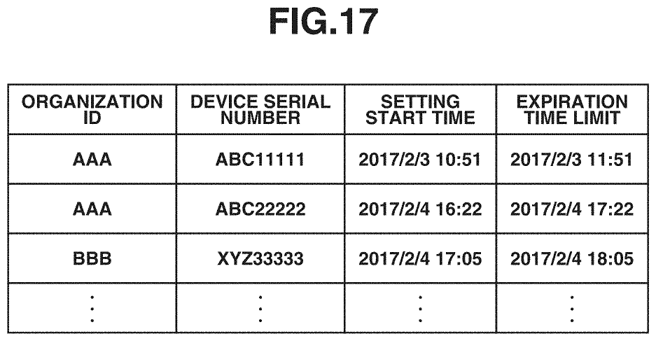

FIG. 17 illustrates an example of a setting history which is stored by the setting history management unit 302 in step S807. A difference from the setting history illustrated in FIG. 13 is that an expiration time limit is stored for each combination of an organization ID and a device serial number. In the present example, one hour from the setting start time is assumed to be an expiration time limit.

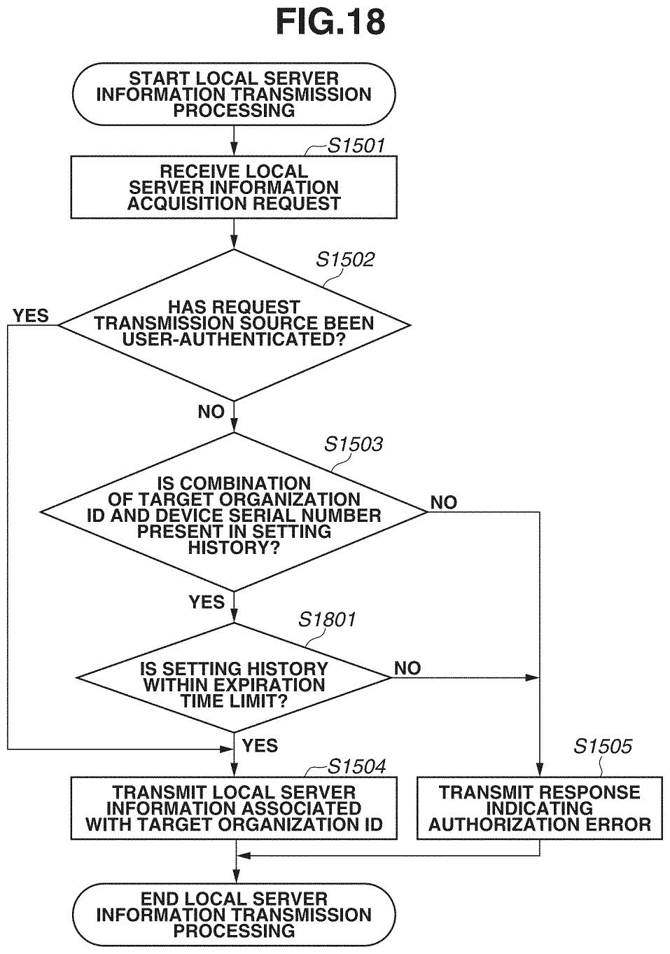

FIG. 18 is a flowchart illustrating an example of local server information transmission processing, which is performed by the management server 101.

In step S1801, the local server management unit 301 determines whether the current time exceeds the expiration time limit of the setting history identified in step S1503. If it is determined that the current time is within the expiration time limit (YES in step S1801), the processing proceeds to step S1504, and, if it is determined that the current time exceeds the expiration time limit (NO in step S1801), the processing proceeds to step S1505. Thus far is the local server information transmission processing in the second exemplary embodiment.

According to the second exemplary embodiment, in a case where the expiration time limit of the setting history is exceeded, local server information is not allowed to be acquired, so that local server information can be more securely acquired by the device 104.

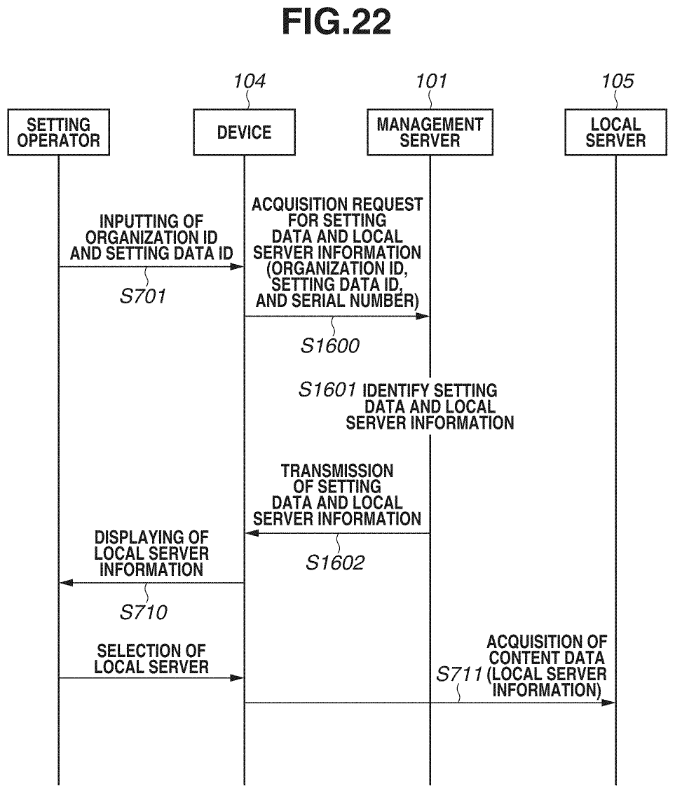

In the above-described exemplary embodiments, a configuration in which, in step S807, the management server 101 stores the setting history in conjunction with reception of a setting data acquisition request and, in step S1503, the management server 101 refers to the setting history in conjunction with reception of a local server information acquisition request and provides local server information to the device 104 has been described. In a third exemplary embodiment, a configuration in which, to reduce the number of times of communication between the device 104 and the management server 101, the management server 101 provides setting data and local server information in response to one request from the device 104 is described. While the third exemplary embodiment is described with reference to FIG. 22, processing operations which have been described in the above-described exemplary embodiments are assigned the respective same reference characters and are, therefore, omitted from description here.

After, in step S701, an organization ID and a setting data ID or only an organization ID is input via a search screen for setting data (FIG. 9), then in step S1600, an acquisition request for setting data and local server information is transmitted from the device 104 to the management server 101. At that time, information input to the search screen (an organization ID and a setting data ID or only an organization ID) and a serial number are transmitted.

In step S1601, the setting data management unit 300 (management server 101) identifies setting data based on information acquired from the device 104. The method of referring to the information illustrated in FIGS. 5A to 5E has been described above in step S802. In the third exemplary embodiment, identifying setting data is also considered as authenticating the device 104.

Moreover, at that time, the management server 101 identifies a local server associated with the organization to which the device 104 belongs with use of the organization ID received from the device 104 and the information illustrated in FIG. 6. The processing content at that time has been described above in step S1504. In a case where, in step S1601, the setting data has not been able to be identified or the local server information has not been identified, a response indicating an error is transmitted with respect to the request transmitted in step S1600.

In step S1602, the setting data and local server information identified in step S1601 are transmitted to the device 104. The processing performed by the device 104 after that is similar to the contents described above in step S710 and step S711. In other words, as can be seen by comparison between FIG. 21 and FIG. 22, steps S1600 to S1602 illustrated in FIG. 22 are equivalent to steps S702 to S1504 illustrated in FIG. 21.

Thus far is the automatic setting processing in the third exemplary embodiment. With this, the number of times of communication between the device 104 and the management server 101 is reduced, and the device 104 is able to access the local server 105 by one authentication processing operation performed on the management server 101 (step S701).

During a period from when searching for setting data is successful (step S702) to when an acquisition request for local server information is transmitted (step S707), the automatic setting processing may be interrupted by the operator and, then, a long period of time may elapse. If, under such a situation, an expiration time limit is provided for the setting history as in the second exemplary embodiment, the expiration time limit for the setting history may be exceeded, so that an error may occur when local server information is acquired (step S1505).

In a fourth exemplary embodiment, a configuration in which, after searching for setting data, even when automatic setting processing is temporarily interrupted, a setting history with an expiration time limit provided therefor can be utilized is described. Furthermore, processing operations and pieces of information which have been described in the above-described exemplary embodiments are assigned the respective same reference characters and are, therefore, omitted from description here.

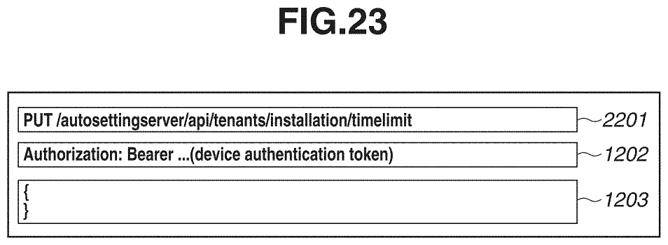

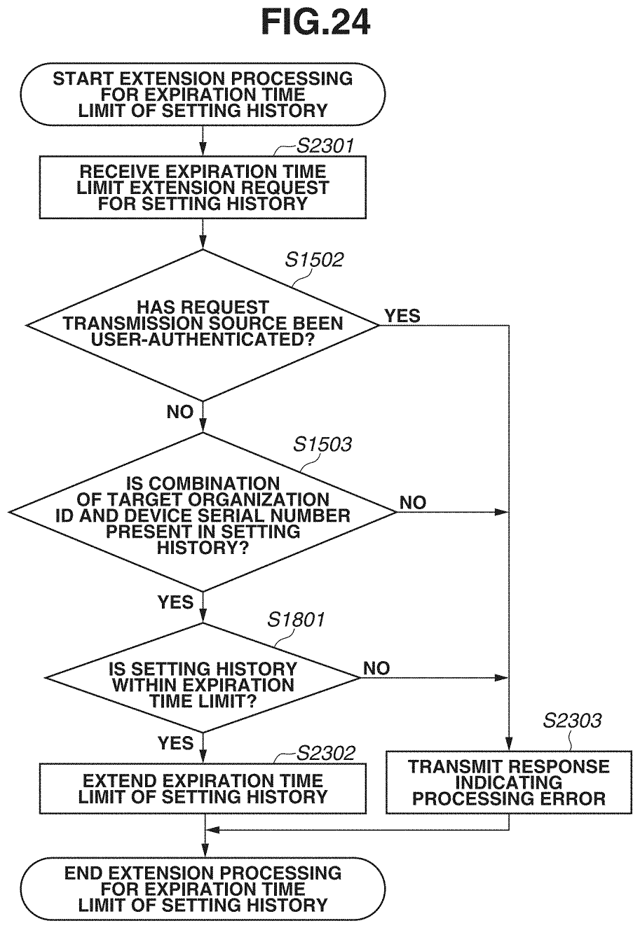

Expiration time limit extension processing which is performed by the management server 101 is described with reference to FIG. 24. First, in step S2301, the local server management unit 301 receives an expiration time limit extension request for a setting history from the setting execution unit 305 of the device 104. FIG. 23 illustrates an example of the expiration time limit extension request which the management server 101 receives. The setting execution unit 305 periodically transmits an expiration time limit extension request such as that illustrated in FIG. 23 to the management server 101 in parallel with the automatic setting processing (FIG. 7) which is in process.

Information 2201 represents an HTTP method and a request URL. The request URL indicates requesting an extension of the expiration time limit of a setting history.

The description refers back to FIG. 24. In step S1502, the local server management unit 301 determines whether the transmission source of the expiration time limit extension request received in step S2301 has been user-authenticated. If it is determined that the transmission source has been user-authenticated (YES in step S1502), then in step S2303, the local server management unit 301 transmits a response indicating a processing error to the device 104. As also mentioned above, the user-authenticated transmission source is a sales representative who generates setting data. Since the expiration time limit is not set when the sales representative acquires content data or acquires setting data, an expiration time limit extension request transmitted from the user-authenticated transmission source is considered as an unauthorized request. If, in step S1502, it is determined that the transmission source has not been user-authenticated (NO in step S1502), the processing proceeds to step S1503.

If, in step S1801, it is determined that the current time is within the expiration time limit of the setting history (YES in step S1801), then in step S2302, the local server management unit 301 extends the expiration time limit of the setting history identified in step S1503. On the other hand, if, in step S1801, it is determined that the current time is not within the expiration time limit of the setting history (NO in step S1801), then in step S2303, the local server management unit 301 transmits a response indicating a processing error to the device 104. Furthermore, the length of the time limit which is extended in step S2302 can be determined based on the expiration time limit designated in the expiration time limit extension request. Moreover, the length of the time limit which is extended can be set in such a way as to restore the length of the original expiration time limit. For example, in a case where the original expiration time limit is “two hours” and the expiration time limit remaining at a point of time when the local server management unit 301 has received the expiration time limit extension request is “1.5 hours”, a method of restoring the original expiration time limit “2 hours” can be considered.

With the above configuration employed, the expiration time limit extension request, which is transmitted from the device 104 to the management server 101, is stopped from being transmitted in conjunction with the automatic setting processing performed by the device 104 ending, so that the expiration time limit of a setting history is also stopped from being extended.

According to the fourth exemplary embodiment, in order to prevent the expiration time limit of a setting history from being exceeded due to delaying of automatic setting processing, it is possible to extend the expiration time limit in a case where the expiration time limit would expire during the process of execution of the automatic setting processing.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-110453 filed Jun. 8, 2018, which is hereby incorporated by reference herein in its entirety.

What is claimed is:

1. An information processing system comprising:
an information processing apparatus;
a management server configured to manage setting data including an instruction to install content data including at least one of an application for implementing a function of the information processing apparatus and firmware for causing the application to operate; and
a local server configured to manage at least a part of the content data,
wherein the management server includes:
an identification unit configured to identify, based on a request from the information processing apparatus, the setting data and local server information including authentication information for accessing the local server; and
an authentication unit configured to authenticate the information processing apparatus,
wherein the management server transmits the setting data and the local server information identified by the identification unit to the information processing apparatus authenticated by the authentication unit, and
wherein, when acquiring the content data according to an instruction included in the setting data acquired from the management server, the information processing apparatus accesses the local server with use of the local server information acquired from the management server and acquires the content data managed by the local server.

2. The information processing system according to claim 1,
wherein the request includes a first identifier for identifying the information processing apparatus and a second identifier for identifying an organization to which the information processing apparatus belongs, and
wherein the authentication unit authenticates the information processing apparatus in association with the setting data being identified with use of the first identifier and the second identifier.

3. The information processing system according to claim 1,
wherein the request includes a first identifier for identifying the information processing apparatus and a third identifier for identifying the setting data, and
wherein the authentication unit authenticates the information processing apparatus in association with the setting data being identified with use of the first identifier and the third identifier.

4. The information processing system according to claim 1, wherein the management server further includes a first management unit configured to manage, in association with authenticating the information processing apparatus, a first identifier for identifying the authenticated information processing apparatus and a second identifier for identifying an organization to which the information processing apparatus belongs.

5. The information processing system according to claim 1,
wherein the management server further includes a second management unit configured to manage the local server information and a fourth identifier for identifying an organization to which the local server belongs while associating the local server information and the fourth identifier with each other,
wherein the identification unit identifies a local server that belongs to an organization to which the information processing apparatus belongs based on the fourth identifier managed by the second management unit, and
wherein the management server transmits the local server information managed by the second management unit to the information processing apparatus.

6. The information processing system according to claim 5, wherein, in a case where a plurality of local servers each corresponding to the local server that belongs to an organization to which the information processing apparatus belongs is identified by the identification unit, the information processing apparatus displays a screen used for a user to select, from the plurality of local servers, the local server from which to acquire the content data.

7. The information processing system according to claim 1, further comprising an external server configured to manage the content data,
wherein the management server further includes a third management unit configured to manage external server information for accessing the external server, and
wherein, in a case where the information processing apparatus is not able to acquire the content data from the local server, the information processing apparatus acquires the external server information managed by the third management unit, accesses the external server with use of the acquired external server information, and acquires the content data managed by the external server.

8. The information processing system according to claim 1, wherein the management server further includes:
a fourth management unit configured to manage, in association with authenticating the information processing apparatus, a first identifier for identifying the authenticated information processing apparatus, a second identifier for identifying an organization to which the information processing apparatus belongs, and an expiration time limit for the first identifier and the second identifier; and
a determination unit configured to determine whether to transmit the setting data to the information processing apparatus based on the expiration time limit managed by the fourth management unit.

9. The information processing system according to claim 8, wherein the information processing apparatus periodically transmits, to the management server, a request to extend the expiration time limit managed by the fourth management unit.

10. A control method for an information processing system including an information processing apparatus, a management server configured to manage setting data including an instruction to install content data including at least one of an application for implementing a function of the information processing apparatus and firmware for causing the application to operate, and a local server configured to manage at least a part of the content data, the control method comprising:
via the management server, identifying, based on a request from the information processing apparatus, the setting data and local server information including authentication information for accessing the local server, and authenticating the information processing apparatus;
via the management server, transmitting the identified setting data and the identified local server information to the authenticated information processing apparatus; and
via the information processing apparatus, when acquiring the content data according to an instruction included in the setting data acquired from the management server, accessing the local server with use of the local server information acquired from the management server and acquiring the content data managed by the local server.
